(19) United States
(12) Patent Application Publication
(10) Pub. No.: US 2005/0123249 A1
(43) Pub. Date: Jun. 9, 2005

(54) Structure for manufacturing optical module

(76) Inventors: Ho Gyeong Yun, Iksan-Shi (KR); Byung Seok Choi, Daejeon-Shi (KR); Jong Hyun Lee, Daejeon-Shi (KR); Kwang Seong Choi, Seoul (KR); Sung Il Kim, Daejeon-Shi (KR); Jong Deog Kim, Daejeon-Shi (KR); Yong Sung Eom, Daejeon-Shi (KR); Jong Tae Moon, Iksan-Shi (KR)

Correspondence Address: JACOBSON HOLMAN PLLC, 400 SEVENTH STREET N.W., SUITE 600, WASHINGTON, DC, 20004, US

(21) Appl. No.: 10/785,008

(22) Filed: Feb. 25, 2004

(30) Foreign Application Priority Data
Dec. 5, 2003 (KR) 2003-88258

(51) Int. Cl. G02B 6/42

(52) U.S. Cl. 385/88

(57) ABSTRACT

Provided is a structure for manufacturing an optical module for fixing optical components needed in modularizing an optical device applied to an optical communication, and contrary to the conventional structure, it is to provide a structure for attaching the optical components that can attach the optical components, such as a coupling lens, a collimator, and a mirror, to the exact place in both directions, and that can locate the lens to the place where the light outputting from the optical device can be precisely adjusted based on light usage, thereby obtaining good optical characteristics.

### BACKGROUND

1. Field of the Invention

The present invention relates to a structure for manufacturing an optical module needed to modularize an optical device to manufacture an independent product and, more particularly, to a structure for manufacturing an optical module, which is applicable to the optical module that can obtain good optical characteristics with a lens arranged to a place where light can be adjusted based on its usage and in which optical components are needed in both directions of an optical device.

2. Discussion of Related Art

Generally, as a structure for manufacturing an optical module, there are fixings, such as a coupling lens, a collimator, a mirror, etc., which are optical components located between an optical device and an optical fiber and adjusting optical characteristics.

For example, in aligning and fixing the collimator, a precisely collimated beam cannot be obtained when it is located and fixed with a simple passive alignment method, thus degrading the performance of the optical module.

Even when an active alignment method rather than the simple passive alignment method is used for aligning and fixing the optical components, in case the conventional structure is used, it was possible to fix the optical components at one side of the optical device. However, there has been a problem that a complex process should be followed, or an extra apparatus is needed since the fixing and aligning the optical components are not easy with a commonly used apparatus, in order to align and fix the optical components in both directions of the optical device.

According to the prior art, when the optical components should be placed in both directions of the optical device, a method that determines a place where the optical components should be placed and fixes the optical components with epoxy or a method that uses active alignment and welding through a horizontal type laser welder have been used.

However, when the method that determines a place where the optical components should be placed using the passive alignment method and fixes the optical components with the epoxy is used, there was a drawback that the optical components cannot be adjusted to an exact place for light passing through the optical components to have desired optical characteristics, thereby degrading the performance of the optical module. Further, in the case that uses the active alignment and welding through the horizontal type laser welder, there were demerits that it uses a structure which is not applicable to a commonly used vertical type laser welder and the process becomes complicated owing to the principle of the horizontal laser welder.

### SUMMARY OF THE INVENTION

The present invention is directed to a structure for manufacturing an optical module with which a modularization process of the optical module requiring optical components in both directions of an optical device is enabled.

Further, the present invention is directed to a method for adjusting optical components to an exact place for light passing through the optical components to have desired optical characteristics, thereby improving the feature of an optical module, when applied to a modularization process of the optical module that optical components should be placed in both directions of an optical device, contrary to the case where a passive alignment method is used.

Further, the present invention is directed to a method for manufacturing an optical module where a relatively simple process can be applied and an extra apparatus is not needed, thus having a relatively low process cost, when fixing optical components with a laser welding process or an epoxy dispensing process, etc.

Further, the present invention is directed to a process available with a vertical laser welder commonly used for placing optical components in both directions of an optical device.

In order to solve the foregoing problems, there is provided a structure for manufacturing an optical module, comprising: a bottom surface on which an optical device is mounted; and outer walls formed at both sides of the bottom surface and making an U-shape together with the bottom surface, and on which holes are formed respectively so that optical components can be attached in both directions of the optical device, wherein light is exchanged between the optical device and the optical components through the holes.

Here, the optical device is a tunable laser diode or a tunable filter, the optical component is a lens or a mirror, the structure is manufactured with a metal, a ceramic, or a polymer, and the hole further comprises a ring. The holes formed on the outer wall have a different size and the outer walls have a different size.

In a preferred embodiment of the present invention, a space is formed between the ring and the holes to make alignment, and at least one of the outer walls of the bottom surface has a protrusive shape.

According to the present invention, by presenting a structure for manufacturing an optical module adjustable in order that light passing through the optical components has a desired characteristic, the manufactured module can have good optical characteristics, and be applicable to the existing apparatus, so that the increase factor of the manufacturing cost can be removed.

There are several kinds of optical devices, and also a number of methods for modularizing each optical device. Most of them need optical components, such as a collimator, a coupling lens, and a mirror, in the process of modularization, and particularly, there are a number of cases that need such optical components in both directions of the optical device.

Meanwhile, the present invention presents a structure applicable to the typically used vertical type laser welder and easy to control exact optical characteristics, in the case where the optical components should be placed in both directions of the optical device.

### BRIEF DESCRIPTION OF THE DRAWINGS

FIG. 1 is a schematic configuration diagram of a structure for manufacturing an optical module according to a preferred embodiment of the present invention;

FIG. 2 is a diagram showing a situation where a structure for manufacturing an optical module according to an embodiment of the present invention is coupled to optical components;

FIG. 3 is an exemplary configuration of a tunable laser module manufactured by using a structure for manufacturing an optical module according to a preferred embodiment of the present invention; and

FIGS. 4 and 5 are schematic configuration diagrams of a structure for manufacturing an optical module according to another embodiment of the present invention.

### DETAILED DESCRIPTION OF PREFERRED EMBODIMENTS

Now the preferred embodiments according to the present invention will be described with reference to the accompanying drawings. Since preferred embodiments are provided for the purpose that the ordinary skilled in the art are able to understand the present invention, they may be modified in various manners and the scope of the present invention is not limited by the preferred embodiments described later.

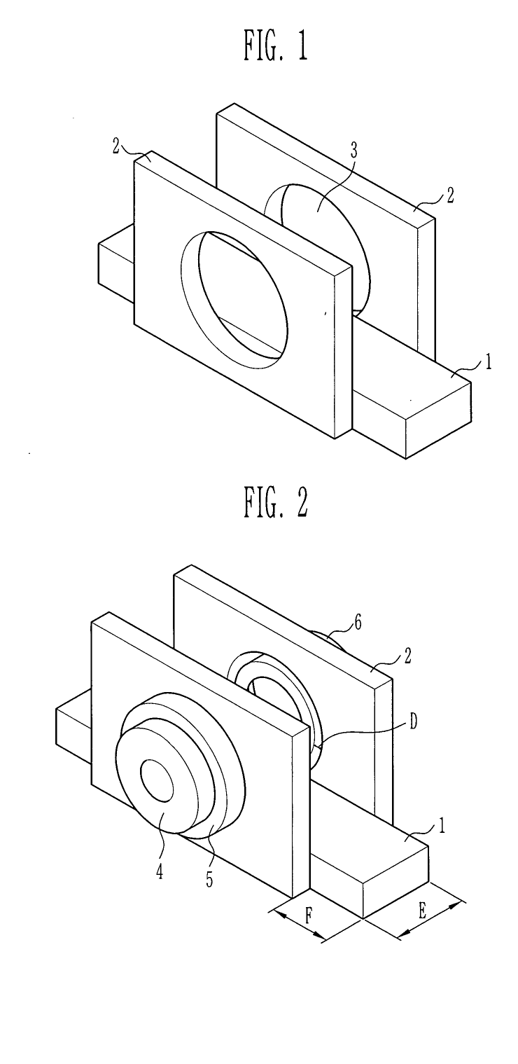

FIG. 1 is a schematic configuration diagram of a structure for manufacturing an optical module according to a preferred embodiment of the present invention.

The structure for manufacturing the optical module comprises a bottom surface 1 on which an optical device is mounted, and outer walls 2, 3 formed at both sides of the bottom surface, thus having an U-shape. Further, holes are formed in each outer wall 2, 3, so that optical components may be attached in both directions of the optical device. Through these holes, light can be exchanged between the optical device and the optical components.

Meanwhile, the optical device that requires the optical components to be placed in both directions is, for example, a tunable-laser diode (LD), or a tunable-filter, etc. Further, the optical components may be a lens, a mirror, and etc.

Meanwhile, the structure for manufacturing the optical module of the present invention can be formed by a metal, or by a ceramic or a polymer. The laser welding method is employed in the case of the structure being formed by the metal, and the epoxy dispensing method is used in the case of the structure being formed by the ceramic or polymer.

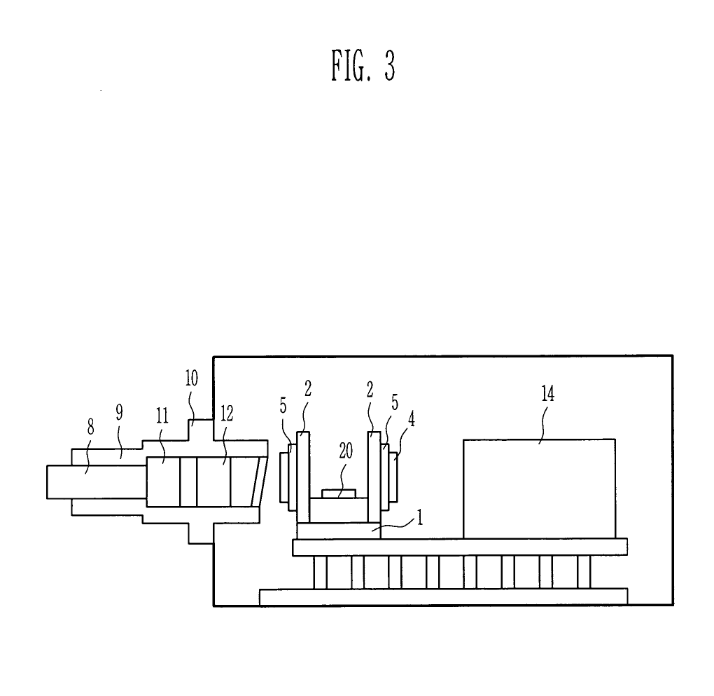

FIG. 2 is a diagram showing a situation where a structure for manufacturing an optical module according to a preferred embodiment of the present invention is coupled to optical components.

Between optical components 4, 6 and holes of the structure for manufacturing the optical module, a ring 5 is further formed. This ring 5 is required to attach a lens, for example, using the laser welding method. That is, serving as a bridge that fixes the optical device and the lens, the ring 5 is inserted into the structure for manufacturing the optical module to be fixed by laser welding. Meanwhile, in order to make alignment possible at this time, a space is required between the ring 5 and the structure for manufacturing the optical module. In FIG. 2, the space is referred to as “D”. For example, the length of “D” is about 200 μm.

Meanwhile, the bottom surface 1 has a protrusion portion protruded to the outside of the outer walls 2 and 3 at a predetermined distance, for example, several mm in order to fix the optical components. The length of the protrusion portion is shown as “F”, and the width of the bottom surface 1 on which the optical device 20 is mounted is shown as “E”. Particularly, such structure having a protrusion portion is desirable when the size of the optical device is small, for example, in the case of a rectangular shape with one side less than 1 mm.

FIG. 3 is an exemplary configuration of a tunable laser module manufactured by using a structure for manufacturing an optical module according to a preferred embodiment of the present invention.

Reference numerals 9 to 12 indicate components and structures for connecting light passing through a lens 4 to an optical fiber 8. Specifically, they correspond to a ferrule 9 manufactured in one body with the optical fiber for connecting the optical fiber using the laser welding, a ferrule housing 10 needed to connect the ferrule to a housing, an isolator 11 for blocking the backward transmission of light reflected from the optical fiber, a lens 12 for collecting light outputting from the optical device 20 into the optical fiber, and an etalon for the stabilization of wavelength, respectively.

According to the present invention, it is possible to obtain light aligned to an optimized place in both directions of the optical module, when connecting the optical components to the optical module using an active alignment method, and the light can be fixed by using several methods, such as laser welding, epoxy, and soldering.

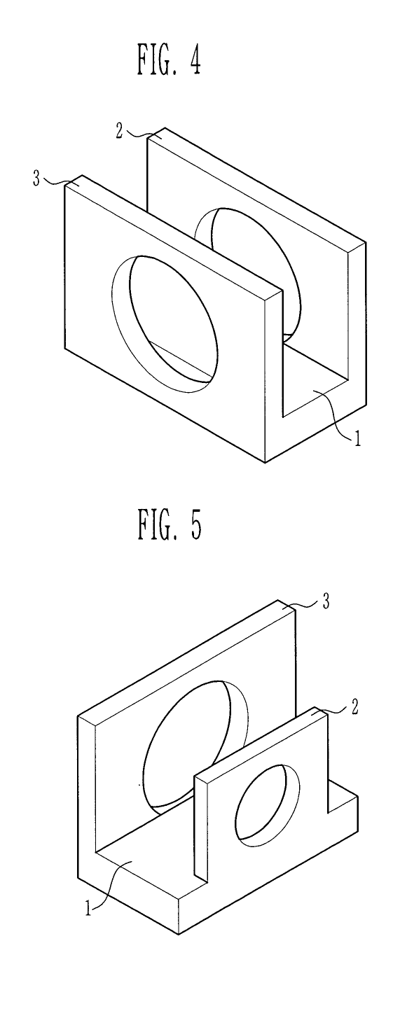

FIG. 4 is a schematic configuration diagram of a structure for manufacturing an optical module according to another embodiment of the present invention.

The difference between the structures for manufacturing the optical module of FIG. 4 and FIG. 1 is an existence of protrusion of the bottom surface. In the structure for manufacturing the optical module of FIG. 1, the bottom surface protrudes outward of the outer walls to fix the optical components, while in the structure for manufacturing the optical module of FIG. 4, the bottom surface does not protrude outward of the outer walls. In FIG. 4, preferably, it is applied to the case, when the size of the optical device is relatively large, in the optical device having a rectangular shape with one side greater than 1 mm.

FIG. 5 is a schematic configuration diagram of a structure for manufacturing an optical module according to still another embodiment of the present invention.

The difference between the structures for manufacturing the optical module of FIG. 5 and FIG. 1 is a size or a shape of both outer walls needed to fix the optical components. Here, the existence of protrusion of the bottom surface can be variously modified. For example, as shown in FIG. 5, it is possible that only one outer wall has a protrusive bottom surface. Further, the size of holes can be variously modified.

As illustrated above, the position of the optical components can be precisely adjusted such that the light passing through the optical components has desired optical characteristics, in case that structure is applied to the modularization process of the optical module where the optical components should be placed in both directions of the optical device, thus improving the feature of the optical module, contrary to the passive alignment.

In addition, the required process becomes simple and an additional apparatus is not needed when the optical components are fixed by using the process, such as laser welding or epoxy dispensing, so that the optical module having the improvement of the optical characteristics and high cost-effective process can be manufactured.

In a packaging process that modularizes the optical device using the optical components, such as a coupling lens, a collimator, and a mirror, the process for fixing the optical components to be used to the exact place for matching with the optical device is needed. According to the present invention, the structure is manufactured such that the optical components can be attached to the exact place in both directions of the optical device.

In case that the optical components required in the modularization process of the optical device are attached by using the structure of the present invention, the optical components can be placed where the optical characteristics is precisely adjusted. Therefore, it is possible to manufacture the module when the optical components are attached in which the desired optical characteristics are precisely implemented, and to make an attachment process without changing an additional apparatus when fixing the optical components using the laser welding or epoxy process, thereby achieving the improvement of the optical characteristics and high cost-effective process.

While the preferred embodiment of the present invention is specifically described, it should be noted that foregoing embodiments are intended for illustration, not for limitation. Further, those skilled in the art will appreciate that a number of embodiments can be made within the scope of the present invention.

1. A structure for manufacturing an optical module, comprising:
a bottom surface on which a optical device is mounted; and
outer walls formed at both sides of the bottom surface and making a U-shape together with the bottom surface, and on which holes are formed respectively so that optical components can be attached in both directions of the optical device,
wherein light is exchanged between the optical device and the optical components through the holes.

2. The structure according to claim 1, wherein the outer walls have a different size.

3. The structure according to claim 1, wherein the optical device is a tunable laser diode or a tunable filter.

4. The structure according to claim 3, wherein the outer walls have a different size.

5. The structure according to claim 1, wherein the optical component is a lens or a mirror.

6. The structure according to claim 5, wherein the outer walls have a different size.

7. The structure according to claim 1, wherein the structure is manufactured with a metal, a ceramic, or a polymer.

8. The structure according to claim 7, wherein the outer walls have a different size.

9. The structure according to claim 1, wherein the hole further comprises a ring.

10. The structure according to claim 9, wherein the outer walls have a different size.

11. The structure according to claim 9, wherein a space is formed between the ring and the holes to make alignment.

12. The structure according to claim 11, wherein the outer walls have a different size.

13. The structure according to claim 1, wherein at least one of the outer walls of the bottom surface has a protrusive shape.

14. The structure according to claim 13, wherein the outer walls have a different size.

15. The structure according to claim 1, wherein the holes formed on the outer wall have a different size.

16. The structure according to claim 15, wherein the outer walls have a different size.
